(19) United States
(12) Patent Application Publication
(10) Pub. No.: US 2014/0126445 A1
(43) Pub. Date: May 8, 2014

(54) APPARATUS AND METHOD FOR DCCH-ALIGNED RECEIVE DIVERSITY

(71) Applicant: QUALCOMM Incorporated, San Diego, CA (US)

(72) Inventors: Nate Chizgi, Sunnyvale, CA (US); Prashant Udupa Sripathi, San Jose, CA (US); Atul Arvind Salvekar, Emeryville, CA (US); Sharif Ahsanul Matin, San Diego, CA (US); Wei Zhang, San Diego, CA (US); Je Woo Kim, Cupertino, CA (US); Shashank V. Maiya, Santa Clara, CA (US)

(73) Assignee: QUALCOMM Incorporated, San Diego, CA (US)

(21) Appl. No.: 14/044,699

(22) Filed: Oct. 2, 2013

Related U.S. Application Data
(60) Provisional application No. 61/723,655, filed on Nov. 7, 2012.

(51) Int. Cl. H04W 52/02

(52) U.S. Cl. CPC H04W 52/0229
USPC 370/311

(57) ABSTRACT

One or more aspects of the present disclosure aim to enable a reduced call drop rate and/or improved call performance in calls using 3GPP Release 99 Dedicated Physical Channel (DPCH) signaling, while reducing, or at least not causing a substantially large rise in power consumption at a wireless device, by utilizing selection diversity at a receiver. According to an aspect of the disclosure, a UE invokes a measurement period for detecting a downlink dedicated control channel (DCCH) based on a condition of a radio channel, during an initial portion of a transmission time interval (TTI). The UE samples one or more characteristics of a radio channel utilizing one or more of a plurality of receive chains. If the DCCH is detected during the measurement period, the UE selects one or more receive chains from among the plurality of receive chains in accordance with the one or more sampled characteristics. The UE receives a downlink transmission utilizing the selected one or more receive chains.

### CROSS-REFERENCE TO RELATED APPLICATIONS

This application claims priority to and the benefit of provisional patent application No. 61/723,655 filed in the United States Patent Office on Nov. 7, 2012, the entire content of which is incorporated herein by reference.

### TECHNICAL FIELD

Aspects of the present disclosure relate generally to wireless communication systems, and more particularly, to wireless receivers configured for receive diversity utilizing a plurality of receive chains.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). UMTS also supports enhanced 3G data communications protocols, such as High Speed Packet Access (HSPA), which provides higher data transfer speeds and capacity to associated UMTS networks.

Generally, a wireless device (e.g., a UMTS user equipment) may be used to receive voice and/or data communications through the wireless communication systems. When receiving data communications, it is generally desirable to have higher data rates for communications to and from the wireless devices, as well as reduced call drops, in order to enhance user experience. Spatial diversity is one commonly used technique to increase data rates and reduce call drops, by utilizing multiple receive and/or transmit chains, coupled to respective spatially separated antennas, to receive and/or transmit data on multiple wireless communication channels. In some examples, data is transmitted by a wireless device using a single transmit chain operably coupled to a primary antenna that operates in duplex with a receive chain that also uses the primary antenna, and a second receive chain, commonly referred to as a diversity receive chain, which may utilize a secondary antenna.

The use of multiple transmit and/or receive chains can be effective in enhancing user experience through higher data transmission rates and/or reduced call drops. However, the use of multiple transmit and/or receive chains may also adversely impact power consumption in the wireless device. Such wireless devices are generally battery operated, and thus, it is of course desirable to increase the amount of time a wireless device can operate using only battery power.

In some examples utilizing spatial diversity, the multiple antennas may be used simultaneously or concurrently, wherein the signals received at each of the antennas may be combined in such a way so as to take advantage of the fact that the different position of each antenna means that it is relatively unlikely that all antennas would be in a deep fade at about the same time. In another example utilizing spatial diversity, called selection diversity, a subset (e.g., less than all) of the receive chains may be selected for use, when it is determined that the subset is at a better spatial location at a particular time. Thus, with one or both of these techniques, the probability of encountering reduced wireless performance due to moving into a location of a deep fade may be dramatically reduced.

As the demand for mobile broadband access continues to increase, research and development continue to advance the UMTS technologies not only to meet the growing demand for mobile broadband access, but to advance and enhance the user experience with mobile communications. For example, it is desirable to improve the power consumption of battery powered wireless devices.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

One or more aspects of the disclosure aim to enable a reduced call drop rate and/or improved call performance in calls using 3GPP Release 99 Dedicated Physical Channel (DPCH) signaling, while reducing, or at least not causing a substantially large rise in power consumption at a wireless device, by utilizing selection diversity at a receiver.

An aspect of the disclosure provides for a method of wireless communication operable at a user equipment (UE) configured for selection diversity. According to the method, the UE invokes a measurement period for detecting a downlink dedicated control channel (DCCH) based on a condition of a radio channel, during an initial portion of a transmission time interval (TTI). The UE samples one or more characteristics of the radio channel utilizing one or more of a plurality of receive chains. If the DCCH is detected during the measurement period, the UE selects one or more receive chains from among the plurality of receive chains in accordance with the one or more sampled characteristics. The LIE receives a downlink transmission utilizing the selected one or more receive chains.

Another aspect of the disclosure provides an apparatus configured for selection diversity. The apparatus includes means for invoking a measurement period for detecting a downlink dedicated control channel (DCCH) based on a condition of a radio channel, during an initial portion of a transmission time interval (TTI); means for sampling one or more characteristics of the radio channel utilizing one or more of a plurality of receive chains; if the DCCH is detected during the measurement period, means for selecting one or more receive chains from among the plurality of receive chains in accordance with the one or more sampled characteristics; and means for receiving a downlink transmission utilizing the selected one or more receive chains.

Another aspect of the disclosure provides an apparatus configured for selection diversity. The apparatus includes at least one processor, a communication interface coupled to the at least one processor, and a memory coupled to the at least one processor. The at least one processor is configured to: invoke a measurement period for detecting a downlink dedicated control channel (DCCH) based on a condition of a radio channel, during an initial portion of a transmission time interval (TTI); sample one or more characteristics of the radio channel utilizing one or more of a plurality of receive chains; if the DCCH is detected during the measurement period, select one or more receive chains from among the plurality of receive chains in accordance with the one or more sampled characteristics; and receive a downlink transmission utilizing the selected one or more receive chains.

Another aspect of the disclosure provides a computer-readable storage medium that includes code. The code causes a user equipment (LIE) configured for selection diversity to: invoke a measurement period for detecting a downlink dedicated control channel (DCCH) based on a condition of a radio channel, during an initial portion of a transmission time interval (TTI); sample one or more characteristics of the radio channel utilizing one or more of a plurality of receive chains; if the DCCH is detected during the measurement period, select one or more receive chains from among the plurality of receive chains in accordance with the one or more sampled characteristics; and receive a downlink transmission utilizing the selected one or more receive chains.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods

### BRIEF DESCRIPTION OF THE DRAWINGS

FIG. 1 is a block diagram illustrating an example of a hardware implementation for an apparatus employing a processing system.

FIG. 2 is a block diagram conceptually illustrating an example of a telecommunications system.

FIG. 3 is a conceptual diagram illustrating an example of an access network.

FIG. 4 is a conceptual diagram illustrating an example of a radio protocol architecture for the user and control plane.

FIG. 5 is a block diagram conceptually illustrating an example of a user equipment configured for combination diversity and/or selection diversity according to some aspects of the disclosure.

FIG. 6 is a schematic diagram of a transmission time interval showing a measurement period and a dwell period in accordance with an aspect of the disclosure.

FIG. 7 is a flow chart illustrating an exemplary process of implementing a downlink dedicated control channel (DCCH)-aligned selection diversity operation in accordance with an aspect of the disclosure.

FIG. 8 is a diagram illustrating some processes for controlling the measurement period in accordance with some aspects of the disclosure.

FIG. 9 is a flow chart illustrating a process for controlling the selective invocation of the measurement period in accordance with an aspect of the disclosure.

FIG. 10 is a flow chart illustrating a method of wireless communication operable at a user equipment configured for selection diversity in accordance with an aspect of the disclosure.

FIG. 11 is a functional block diagram illustrating a processor and a computer-readable medium configured for DCCH-aligned receive diversity in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

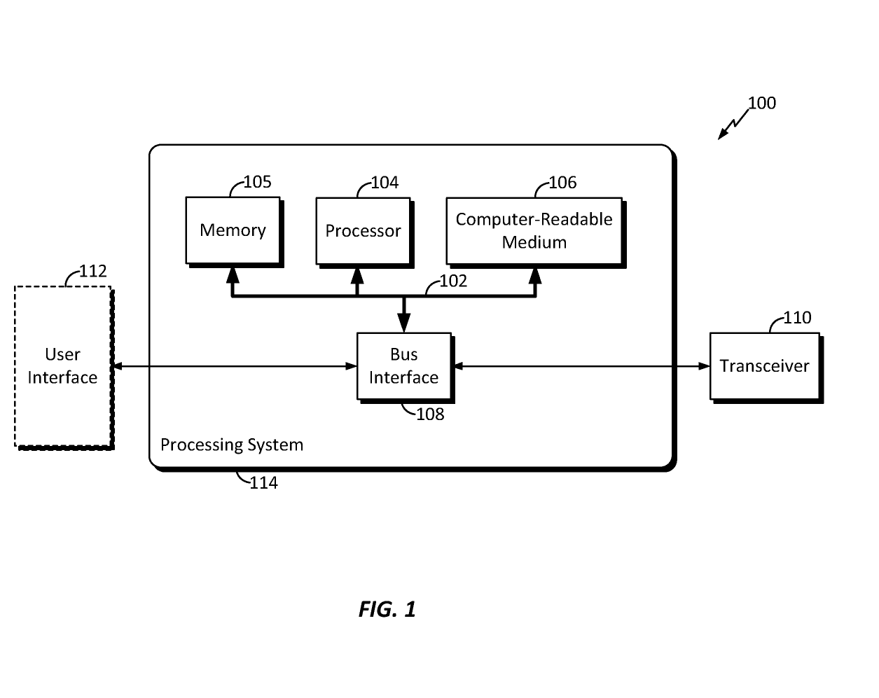

FIG. 1 is a conceptual diagram illustrating an example of a hardware implementation for an apparatus 100 employing a processing system 114. In accordance with various aspects of the disclosure, an element, or any portion of an element, or any combination of elements may be implemented with a processing system 114 that includes one or more processors 104. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In an aspect of the disclosure, a user equipment capable of spatial diversity operation for a UMTS network may be implemented with the apparatus 100.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors (represented generally by the processor 104), a memory 105, and computer-readable media (represented generally by the computer-readable medium 106). The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a communication interface or means for communicating with various other apparatus over a transmission medium. In some aspects of the disclosure, the transceiver 100 may be configured for spatial diversity operation. Depending upon the nature of the apparatus, a user interface 112 (e.g., keypad, display, speaker, microphone, joystick) may also be provided.

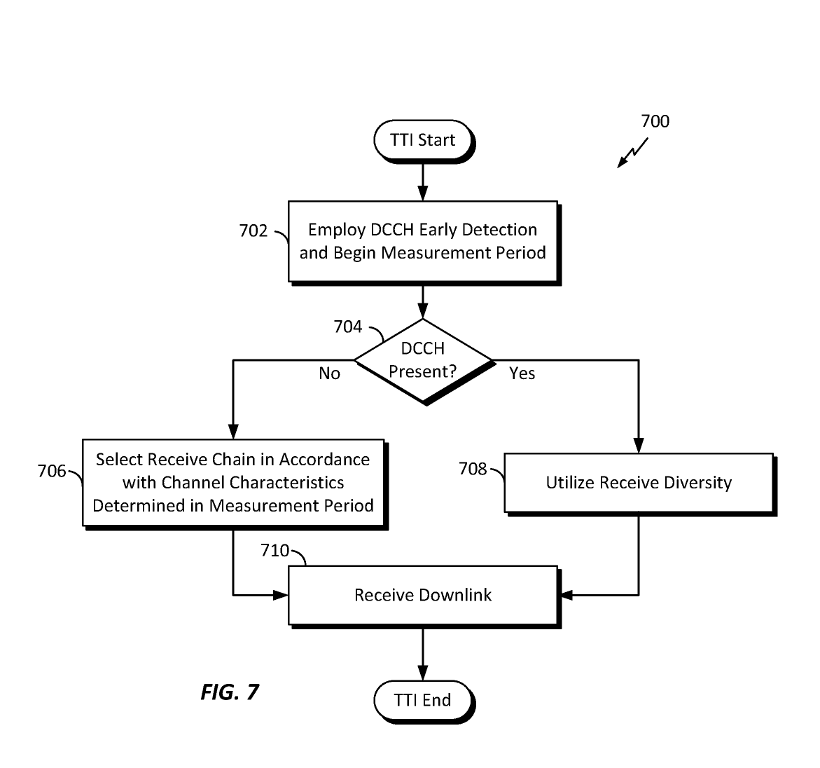

The processor 104 is responsible for managing the bus 102 and general processing, including the execution of software stored on the computer-readable medium 106. The software, when executed by the processor 104, causes the processing system 114 to perform the various functions described in reference to FIGS. 7 to 11. The various functions can be performed by different components of the processor 104 configured by the software. In some aspects of the disclosure, the various functions include diversity operations utilizing multiple receive chains to be described in more detail below. The computer-readable medium 106 may also be used for storing data that is manipulated by the processor 104 when executing software.

One or more processors 104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer.

The computer-readable medium 106 may reside in the processing system 114, external to the processing system 114, or distributed across multiple entities including the processing system 114. The computer-readable medium 106 may be embodied in a computer program product. By way of example, a computer program product may include a computer-readable medium in packaging materials. Those skilled in the art will recognize how best to implement the described functionality presented throughout this disclosure as illustrated in FIGS. 1-11 depending on the particular application and the overall design constraints imposed on the overall system.

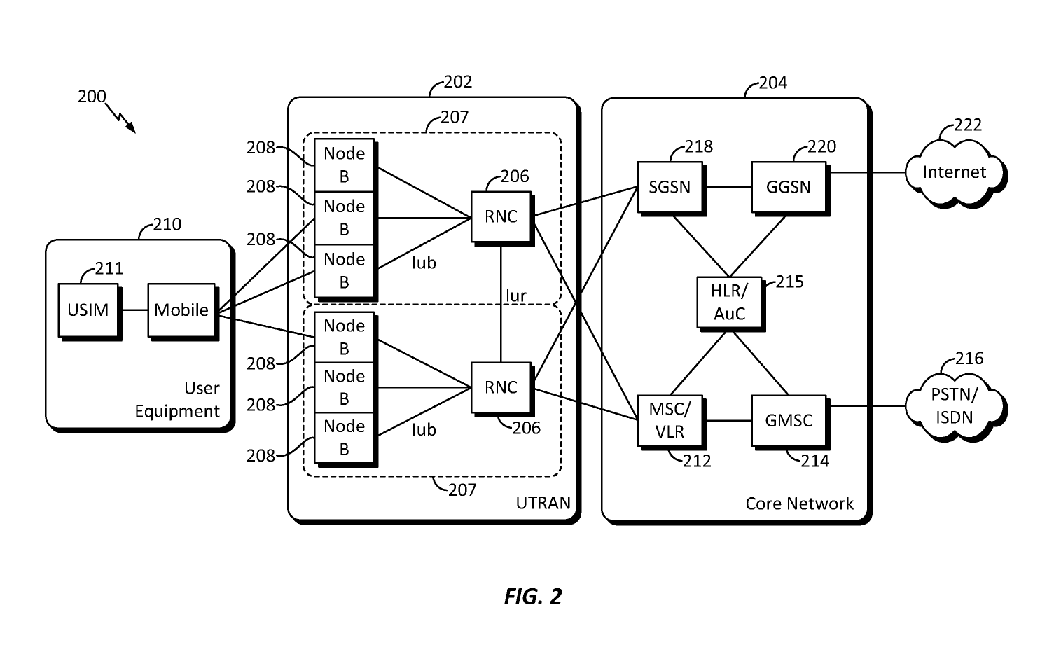

The various concepts presented throughout this disclosure may be implemented across a broad variety of telecommunication systems, network architectures, and communication standards. Referring now to FIG. 2, as an illustrative example without limitation, various aspects of the present disclosure are illustrated with reference to a Universal Mobile Telecommunications System (UMTS) system 200, A UMTS network includes three interacting domains: a core network 204, a radio access network (RAN) (e.g., the UMTS Terrestrial Radio Access Network (UTRAN) 202), and a user equipment (UE) 210. In some aspects of the disclosure, the UE 210 may be implemented with the apparatus 100. Among several options available for a UTRAN 202, in this example, the illustrated UTRAN 202 may employ a W-CDMA air interface for enabling various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring, and releasing radio resources within the RNS 207. The RNC 206 may be interconnected to other RNCs (not shown) in the UTRAN 202 through various types of interfaces such as a direct physical connection, a virtual network, or the like using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network 204 for any number of mobile apparatuses. Examples of a mobile apparatus include a cellular phone, a smart phone, a session initiation protocol (SIP) phone, a laptop, a notebook, a tablet, a netbook, a smartbook, a personal digital assistant (PDA), a satellite radio, a global positioning system (GPS) device, a multimedia device, a video device, a digital audio player (e.g., MP3 player), a camera, a game console, or any other similar functioning devices. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210 and the uplink (UL), also called the reverse link, refers to the communication link from a UE 210 to a Node B 208.

The core network 204 can interface with one or more access networks, such as the UTRAN 202. As shown, the core network 204 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 204 includes a circuit-switched (CS) domain and a packet-switched (PS) domain. Some of the circuit-switched elements are a Mobile services Switching Centre (MSC), a. Visitor Location Register (VLR), and a. Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The illustrated core network 204 also supports packet-switched data services with a serving GPRS support node (SGSN) 218 and a gateway GPRS support node (GGSN) 220. General Packet Radio Service (GPRS) is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

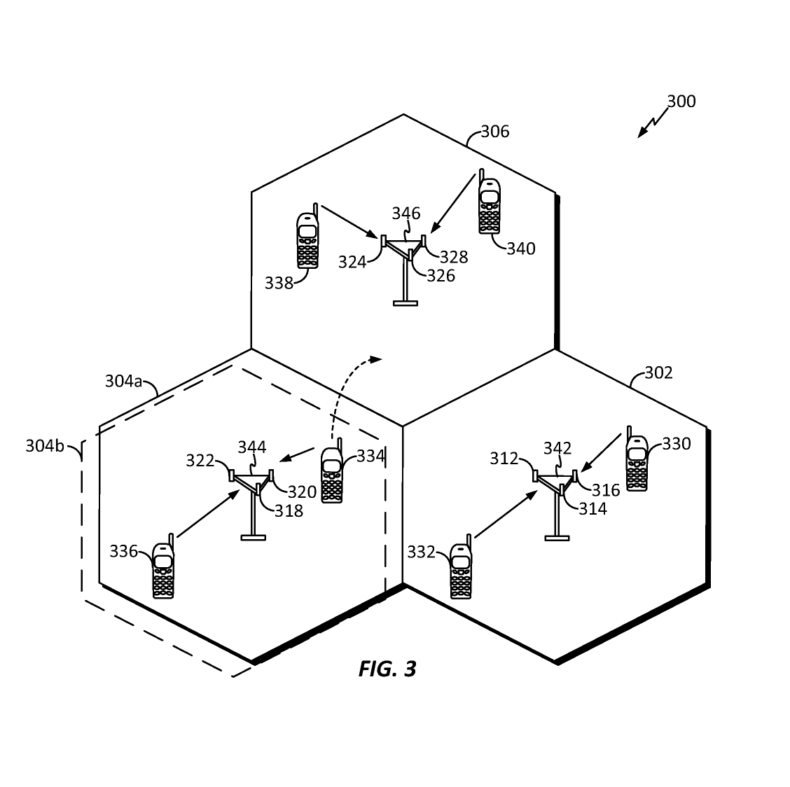

The UTRAN 202 is one example of a RAN that may be utilized in accordance with the present disclosure. Referring to FIG. 3, by way of example and without limitation, a simplified schematic illustration of a RAN 300 in a UTRAN architecture is illustrated. The system includes multiple cellular regions (cells), including cells 302, 304, and 306, each of which may include one or more sectors. Cells may be defined geographically (e.g., by coverage area) and/or may be defined in accordance with a frequency, scrambling code, etc. That is, the illustrated geographically-defined cells 302, 304, and 306 may each be further divided into a plurality of cells, e.g., by utilizing different scrambling codes. For example, cell 304a may utilize a first scrambling code, and cell 304b, while in the same geographic region and served by the same Node B 344, may be distinguished by utilizing a second scrambling code.

In a cell that is divided into sectors, the multiple sectors within a cell can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 may each correspond to a different sector. In cell 306, antenna groups 324, 326, and 328 may each correspond to a different sector.

The cells 302, 304, and 306 may include several UEs that may be in communication with one or more sectors of each cell 302, 304, or 306. For example, UEs 330 and 332 may be in communication with Node B 342, UEs 334 and 336 may be in communication with Node B 344, and UEs 338 and 340 may be in communication with Node B 346. Here, each Node B 342, 344, and 346 may be configured to provide an access point to a core network 204 (see FIG. 2) for all the UEs 330, 332, 334, 336, 338, and 340 in the respective cells 302, 304, and 306.

During a call with a source cell, or at any other time, the UE 336 may monitor various parameters of the source cell as well as various parameters of neighboring cells. Further, depending on the quality of these parameters, the UE 336 may maintain communication with one or more of the neighboring cells. During this time, the UE 336 may maintain an Active Set, that is, a list of cells to which the UE 336 is simultaneously connected (i.e., the UTRAN cells that are currently assigning a downlink dedicated physical channel DPCH or fractional downlink dedicated physical channel F-DPCH to the UE 336 may constitute the Active Set).

In a wireless telecommunication system, the communication protocol architecture may take on various forms depending on the particular application. For example, in a 3GPP UMTS system, the signaling protocol stack is divided into a Non-Access Stratum (NAS) and an Access Stratum (AS). The NAS provides the upper layers, for signaling between the UE 210 and the core network 204 (referring to FIG. 2), and may include circuit switched and packet switched protocols. The AS provides the lower layers, for signaling between the UTRAN 202 and the UE 210, and may include a user plane and a control plane. Here, the user plane or data plane carries user traffic, while the control plane carries control information (i.e., signaling).

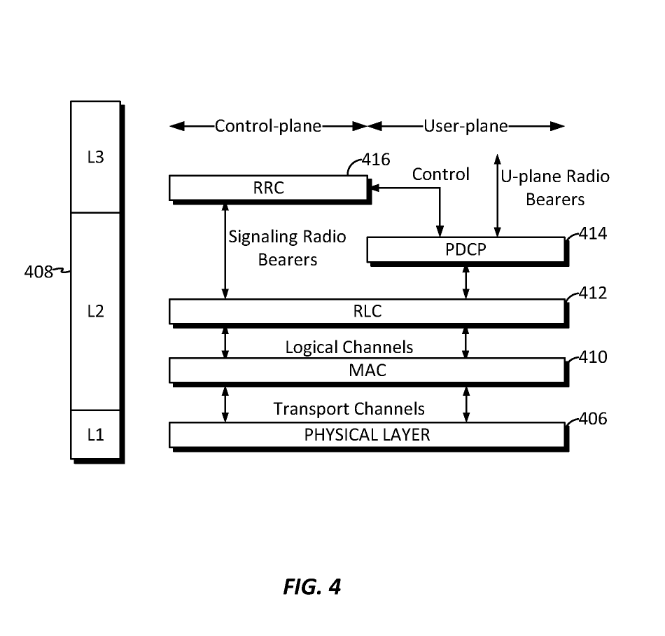

Turning to FIG. 4, the AS is shown with three layers: Layer 1, Layer 2, and Layer 3. Layer 1 is the lowest layer and implements various physical layer signal processing functions. Layer 1 will be referred to herein as the physical layer 406. The data link layer, called Layer 2 408, is above the physical layer 406 and is responsible for the link between the UE 210 and Node B 208 over the physical layer 406.

At Layer 3, the RRC layer 416 handles the control plane signaling between the UE 210 and the Node B 208. RRC layer 416 includes a number of functional entities for routing higher layer messages, handling broadcasting and paging functions, establishing and configuring radio bearers, etc.

In the illustrated air interface, the L2 layer 408 is split into sublayers. In the control plane, the L2 layer 408 includes two sublayers: a medium access control (MAC) sublayer 410 and a radio link control (RLC) sublayer 412. In the user plane, the L2 layer 408 additionally includes a packet data convergence protocol (PDCP) sublayer 414. Although not shown, the UE may have several upper layers above the L2 layer 408 including a network layer (e.g., IP layer) that is terminated at a PDN gateway on the network side and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between Node Bs.

The RLC sublayer 412 generally supports an acknowledged mode (AM) (where an acknowledgment and retransmission process may be used for error correction), an unacknowledged mode (UM), and a transparent mode for data transfers, and provides segmentation and reassembly of upper layer data packets and reordering of data packets to compensate for out-of-order reception due to a hybrid automatic repeat request (HARQ) at the MAC layer. In the acknowledged mode, RLC peer entities such as an RNC and a UE may exchange various RLC protocol data units (PDUs) including RLC Data PDUs, RLC Status PDUs, and RLC Reset PDUs, among others. In the present disclosure, the term “packet” may refer to any RLC PDU exchanged between RLC peer entities.

The MAC sublayer 410 provides multiplexing between logical and transport channels. The MAC sublayer 410 is also responsible for allocating the various radio resources (e.g., resource blocks) in one cell among the UEs. The MAC sublayer 410 is also responsible for HARQ operations.

The UTRAN air interface may be a spread spectrum Direct-Sequence Code Division Multiple Access (DS-CDMA) system, such as one utilizing the W-CDMA standards. The spread spectrum DS-CDMA spreads user data through multiplication by a sequence of pseudorandom bits called chips. The W-CDMA air interface for the UTRAN 202 is based on such DS-CDMA technology and additionally calls for a frequency division duplexing (FDD). FDD uses a different carrier frequency for the uplink (UL) and downlink (DL) between a Node B 408 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface or any other suitable air interface.

A high speed packet access (HSPA) air interface includes a series of enhancements to the 3G/W-CDMA air interface between the UE 210 and the UTRAN 202, facilitating greater throughput and reduced latency for users. Among other modifications over prior standards, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink or EUL).

For example, in Release 5 of the 3GPP family of standards, HSDPA was introduced. HSDPA utilizes as its transport channel the high-speed downlink shared channel (HS-DSCH), which may be shared by several UEs. The HS-DSCH is implemented by three physical channels: the high-speed physical downlink shared channel (HS-PDSCH), the high-speed shared control channel (HS-SCCH), and the high-speed dedicated physical control channel (HS-DPCCH).

The HS-SCCH is a physical channel that may be utilized to carry downlink control information related to the transmission of HS-DSCH. Here, the HS-DSCH may be associated with one or more HS-SCCH. The UE may continuously monitor the HS-SCCH to determine when to read its data from the HS-DSCH and to determine the modulation scheme used on the assigned physical channel.

The HS-PDSCH is a physical channel that may be shared by several UEs and may carry downlink data for the high-speed downlink. The HS-PDSCH may support quadrature phase shift keying (QPSK), 16-quadrature amplitude modulation (16-QAM), and multi-code transmission.

The HS-DPCCH is an uplink physical channel that may carry feedback from the UE to assist the Node B in its scheduling algorithm. The feedback may include a channel quality indicator (CQI) and a positive or negative acknowledgement (ACK/NAK) of a previous HS-DSCH transmission.

One difference on the downlink between Release-5 HSDPA and the previously standardized circuit-switched air-interface is the absence of soft handover in HSDPA. This means that HSDPA channels are transmitted to the UE from a single cell called the HSDPA serving cell. As the user moves, or as one cell becomes preferable to another, the HSDPA serving cell may change. Still, the UE may be in soft handover on the associated DPCH, receiving the same information from plural cells.

In Release 5 HSDPA, at any instance a LIE 210 has one serving cell: the strongest cell in the active set as according to the UE measurements of E_{c}/I₀. According to mobility procedures defined in Release 5 of 3GPP TS 25.331, the radio resource control (RRC) signaling messages for changing the HSPDA serving cell are transmitted from the current HSDPA serving cell (i.e., the source cell) and not the cell that the UE reports as being the stronger cell (i.e., the target cell).

One or more aspects of the disclosure aim to enable a reduced call drop rate and/or improved call performance in calls using 3GPP Release 99 DPCH signaling, while reducing, or at least not causing a substantially large rise in power consumption at a wireless device such as the UE 210, by utilizing selection diversity at a receiver in accordance with certain conditions.

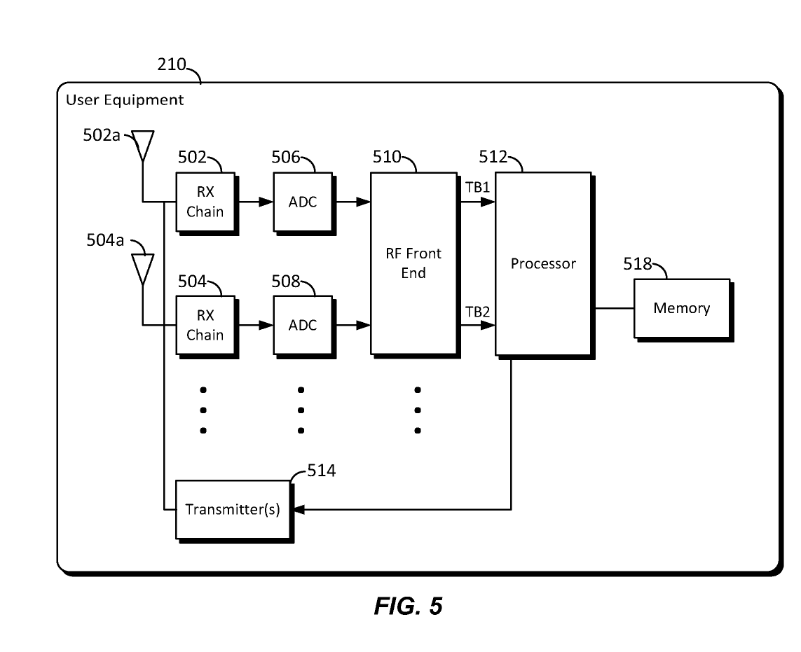

FIG. 5 is a simplified block diagram illustrating some of the components of an exemplary UE 210 that may be utilized for downlink combination diversity, and/or selection diversity, in accordance with some aspects of the present disclosure. In the illustration, the UE 210 includes two receive chains 502 and 504 for receiving respective downlink signals via, their respective antennas 502a and 504a. However, within the scope of the present disclosure, a UE 210 may include any suitable number of receive chains for receiving downlink signals.

Coupled to the receive chains 502 and 504 may be respective analog-to-digital converters (ADCs) 506 and 508, which may transform the received downlink channels to the digital domain to be further processed by an RF front end 510. The RF front end 510 may then provide the received transport blocks to a processor 512 to be further processed in accordance with the received information. The processor 512 may additionally be coupled to one or more transmitters 514, which may utilize one or more of the UE's antennas as managed by a suitable duplexer (not shown). The processor 512 may additionally utilize a memory 518 for storing information useful for the processing of the information. In some examples, the memory 518 may be the same as the memory 105 illustrated in FIG. 1.

In any wireless communications device including the UE 210, call drop performance depends in a large part on the reliability of reception of control signaling. For example, it has been observed that dropped calls in a conventional network may tend to be caused in part by missed signaling messages transmitted on the downlink dedicated control channel (DCCH). The DCCH is a point-to-point bidirectional channel (logical) that transmits dedicated control information between the UE 210 and the RNC 206. This channel is established during the RRC connection establishment procedure. The data packets arriving from the DCCH logical channel are handled at the MAC layer 410 and mapped to the appropriate transport channels. The control signaling on the DCCH, which is transmitted somewhat infrequently, provides information, e.g., relating to the activating of a compressed mode, adding cells to the active set, or other such information that can influence the fidelity of a call.

In a conventional system utilizing selection diversity, retention of the control channel (e.g., DCCH) signaling is not necessarily emphasized or considered in the selection among the receive chains. That is, the conventional approach to selection diversity generally does not take such control channel signaling into account during a measurement period (described further below) when implementing selection diversity.

However, in an aspect of the present disclosure, the UE 210 may be adapted to consider control channel signaling, e.g., signaling carried upon the DCCH, during the measurement period utilized for implementing selection diversity, in order to improve the probability of proper reception of these signaling messages. That is, according to one or more aspects of the present disclosure, selection diversity at a wireless device may be enabled based at least in part upon certain knowledge of properties of the control signaling (e.g., signaling on the DCCH), such that call drop rates can be reduced relative to conventional selection diversity, while reducing, or at least not substantially increasing the power consumption of the UE.

Measurement Period

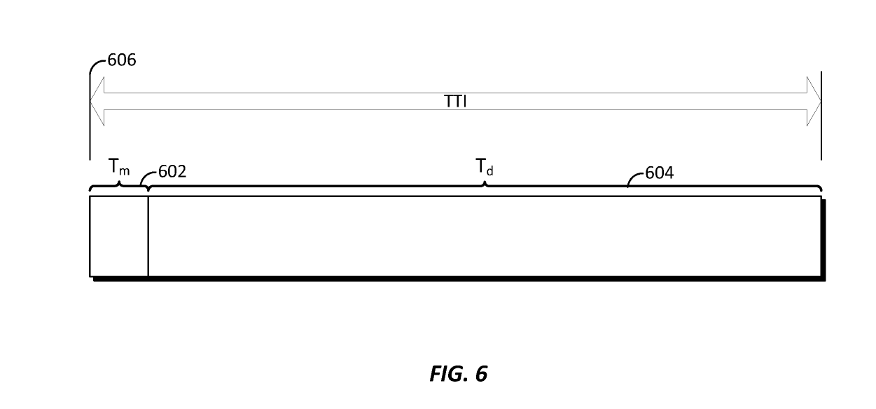

As indicated above, when implementing selection diversity, a. UE 210 may utilize a measurement period (Tₘ) 602 (see FIG. 6) where all receive chains (e.g., Rx chains 502, 504) are enabled to perform the selection criteria, and a dwell period (T_{d}) 604 where a subset of the receive chains (e.g., only one receive chain) is enabled for receiving signals. This measurement period Tₘ may be relatively brief. The measurement period Tₘ may be between zero percent and one hundred percent, inclusive, of the TTI. For example, if measurement is not needed, the measurement period Tₘ can be zero percent. If continuous measurement is desired to take full advantage between the diversity modes, the measurement period Tₘ can be as much as one hundred percent. In an aspect of the disclosure, the measurement period Tₘ is between five percent and twenty percent.

During the measurement period Tₘ, one or more characteristics of a radio channel may be sampled utilizing each of the receive antennas (e.g., antennas 502a, 504a). For example, each receive chain may be characterized according to its spatial location, and for each receive chain, characteristics including but not limited to a total input power (Iₒᵣ) for each receive antenna; a common pilot channel (CPICH) power and noise ratio (CPICH SNR) for each receive antenna; a CPICH E_{c}/I₀ for each receive antenna (i.e., the CPICH power within a chip over the entire received power (signal plus noise)); and/or a dedicated physical channel (DPCH) power and noise ratio (DPCH SNR) for each receive antenna, may be determined. Upon determining these one or more characteristics of the radio channel for each of the spatially separated receive antennas, selection of a subset (e.g., one) of the receive chains may be made in accordance with the sampled characteristics.

DCCH Early Detection

In an aspect of the disclosure, a UE 210 may be enabled to determine, with some probability, whether control signaling of a control channel (e.g., the DCCH) is present during a particular transmission time interval (TTI). In general, the presence of the control signaling of the DCCH may generally be determined with certainty at the end of the TTI, by calculating a cyclic redundancy check (CRC). However, a DCCH early detection mechanism has been published, in which the presence of the DCCH may be determined with relatively high probability during a short period of time at the beginning of a TTI. The early detection of DCCH can be achieved through early Transport Format Combination Indicator (TFCI) demodulation and likelihood binning, or through an energy based detection where TFCI is not present. For example, a DCCH transmission may have a duration of 40 milliseconds (ms). By utilizing the above-described DCCH early detection mechanism, with a high degree of reliability, the presence of the control signaling on the DCCH may be detected within about 4 ins to 6 ms, taking place at the beginning of the TTI.

In accordance with an aspect of the disclosure, in order to improve the performance of DCCH reception/detection, combination diversity (e.g., receive diversity utilizing two or more receive chains in parallel) may be utilized in a particular TTI when the DCCH early detection mechanism determines that the DCCH is present in that particular TTI. In an aspect of the disclosure, all receive chains may be enabled when the DCCH is present. To this end, in a further aspect of the disclosure, the UE may substantially align the measurement period Tₘ 602 utilized for determining whether to invoke selection diversity or combination diversity, such that the measurement period Tₘ 602 takes place or begins at the beginning 606 of a TTI.

In this way, during the measurement period Tₘ if it appears to the UE that the DCCH 608 is present in a TTI (hereafter “DCCH TTI”), then the UE may utilize combination diversity during the remaining portion of the DCCH TTI (e.g., T_{d} 604). As a result, the call drop rate may be reduced on account of the improved probability of successfully receiving the control signaling of the DCCH when utilizing combination diversity.

On the other hand, if it appears to the UE that the DCCH is absent in a particular TTI, the UE may utilize selection diversity, turning off one or more of the receive chains for the remaining portion of the TTI (e.g., T_{d} 604). In this way, power consumption of the UE may be reduced during the time intervals or TTIs when the DCCH is not present or detected. In a typical UMTS network, the DCCH transmission is present during a small portion of the time when a UE is communicating with the network, so the power savings of turning off some receive chains when DCCH is not present can be substantial as compared to a UE that utilizes combination diversity at all times.

FIG. 7 is a flow chart illustrating an exemplary process 700 operable at a UE 210 for performing a DCCH-aligned selection diversity operation in accordance with an aspect of the disclosure. At the start 606 of a TTI, at step 702 the UE may employ a DCCH early detection operation as described above, and in substantial time-alignment (e.g., starting within +/−2 to 3 milliseconds of the TTI boundary) between the start of the TTI and the DCCH early detection algorithm, the UE may further turn on all receive chains (e.g., Rx chains 502, 504) and begin the selection diversity measurement period Tₘ 602. At step 704 the UE may determine, in accordance with the DCCH early detection operation, whether the DCCH is present. If the DCCH is present, then at step 708 the UE may utilize combination diversity (e.g., all receive chains enabled), thereby reducing the probability of failing to decode the DCCH, and accordingly reducing the probability of a call drop. On the other hand, if the DCCH is not present, then at step 706 the UE may select a subset (e.g., one receive chain) of the receive chains to perform selection diversity in accordance with channel characteristics determined during the measurement period begun at step 702. In this way, power consumption can be reduced at the UE relative to that occurring when utilizing combination diversity. In some aspects of the disclosure, the channel characteristics may be measured during other suitable periods in addition to the measurement periods Tₘ 602.

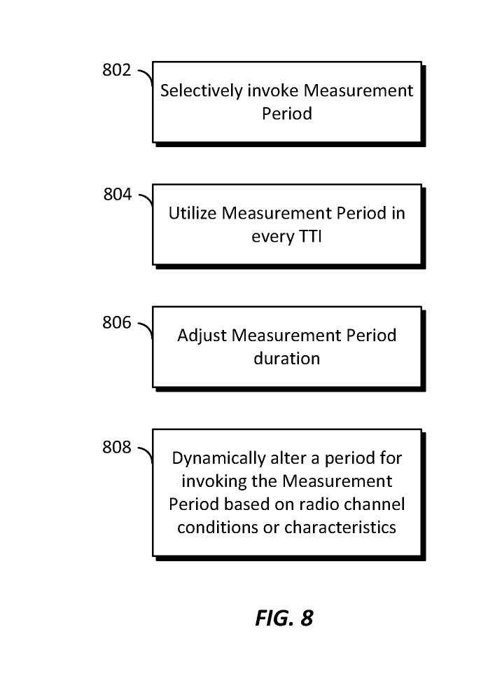

In a further aspect of the disclosure, the measurement period Tₘ 602 may be reduced or even eliminated in certain circumstances, e.g., relating to radio channel conditions determined at the UE. FIG. 8 is a diagram illustrating some processes that may be performed in the step 702 to control the measurement period in accordance with various aspects of the invention. In accordance with an aspect of the disclosure, the beginning or invocation of the measurement period (e.g., Tₘ 602) may be optional (selective) in any given TTI. That is, the UE may selectively invoke the measurement period to detect the DCCH based on certain conditions to be described in more detail below. In an aspect of the disclosure, the conditions for invoking the measurement may be a condition of a radio channel such as a channel condition of the DPCH or CPICH.

For example, the UE may selectively invoke or forgo the measurement period in only some of the TTIs (process 802), or every TTI (process 804). Further, even when the measurement period is utilized in a given TTI, the duration of the measurement period may be adjusted (process 806) relative to conventional selection diversity implementations. In an aspect of the disclosure, the UE may selectively adjust the measurement period from a first duration to a second duration in accordance with the characteristics or conditions of the radio channel. The range of the measurement period Tₘ can be adjusted from as little as zero percent (first duration) of the TTI as mentioned above, to as much as one hundred percent (second duration) depending on the use model and case. In various aspects of the disclosure, the first duration and second duration can be any suitable values between 0 and 100 percent of the TTI, inclusive.

In an aspect of the disclosure, the measurement period may occur less frequently than every TTI. In one example, rather than turning on all receive chains to perform the measurement period during every TTI, a UE 210 may only perform combination diversity for the measurement period during every second or more TTIs, while utilizing selection diversity in the other TTIs. Of course, the invocation of the measurement period during every second or more TTIs is merely one example, and in various examples within the scope of the present disclosure, the measurement period may be invoked in any suitable subset of the TTIs, utilizing any suitable patterns or frequency.

In a further aspect of the disclosure, the aforementioned radio channel conditions or characteristics utilized for determining whether or not to invoke the measurement period, may additionally or alternatively be utilized to dynamically alter a period for the invocation of the measurement period in a subset of the TTIs (process 808). For example, certain conditions may lead to more frequent utilization of the measurement period, while other conditions may lead to less frequent utilization of the measurement period.

In various aspects of the disclosure, the invocation of the measurement period Tₘ during a given TTI may be conditional upon one or more suitable conditions. For example, these conditions may include one or more conditions or characteristics of the radio channel as determined by the LIE 210. That is, the UE may measure various characteristics of a radio channel continuously or, in some examples, relatively frequently, such that the measurements may thereby be available for use in a given TTI to determine whether or not to invoke the measurement period for selection diversity.

For example, the conditions or characteristics for determining whether or not to invoke the measurement period Tₘ in a particular TTI may include one or more of the power of a downlink dedicated physical channel (DPCH); a signal-to-interference ratio estimate (SIRE) of the downlink DPCH; an operating signal-to-interference ratio target (SIRT); a geometry of a cell; a traffic-to-pilot ratio (TPR); a ratio of received pilot energy (Ec) to total received energy (Io) (Ec/Io), and/or the quality (e.g., signal-to-noise ratio (SNR)) of a common pilot channel (CPICH).

Here, the SIRE, an estimate of a ratio between traffic and interference, is an estimate of the DPCH signal power, divided by the sum of received noise and interference. Further, the SIRT is a target level to which a power control algorithm may attempt to converge to from the value of SIRE.

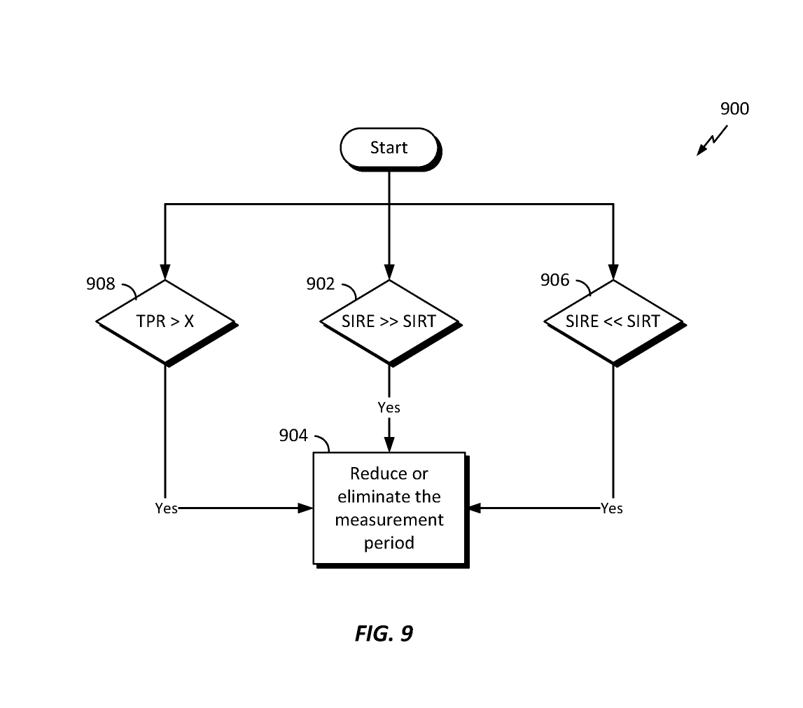

FIG. 9 is a flow chart illustrating a process 900 for controlling the selective invocation of the measurement period Tₘ 602 in accordance with aspects of the disclosure. In an aspect of the disclosure, the process 900 may be performed by a UE 210. In step 902, if the SIRE is substantially larger than the SIRT by a predetermined amount (e.g., 3 dB or more), then this can indicate that the network is allocating to the UE more power than the UE needs; possibly because the network is already transmitting at its minimum transmit level. Thus, in this scenario, it may not be necessary to utilize combination diversity to attempt to improve the downlink, and accordingly, the measurement period Tₘ may be reduced or eliminated in step 904. Therefore, the UE can forgo the measurement period when it is not needed.

In step 906, in another aspect of the disclosure, if the SIRE is substantially lower than the SIRT by a predetermined amount (e.g., 3 dB or more), then this may indicate the network is struggling to provide the UE with the power it needs. Thus, in this scenario, combination diversity may be enabled to improve the downlink as much as possible; and therefore, the employment of the measurement period Tₘ, for selection diversity, may again be unnecessary, and the measurement period may be reduced or eliminated in step 904.

In a further aspect of the disclosure, the invocation of the measurement period Tₘ may be conditionally based upon the traffic-to-pilot ratio TPR. Here, the TPR is the dedicated channel (DPCH) signal power divided by the CPICH signal power. In step 908, if the TPR is larger than a predetermined value (e.g., a value X between 0 dB and 8 dB, inclusive), then this may indicate that the network is allocating substantial power to the UE, and therefore the LIE may be a large contributor to the overall cell capacity. In this scenario, combination diversity may be enabled to provide the highest data rate to the UE; and thus, the employment of the measurement period Tₘ for selection diversity may once again be unnecessary, and the measurement period may be reduced or eliminated in step 904. In an aspect of the disclosure, the process 900 may be performed in the step 702 of FIG. 7.

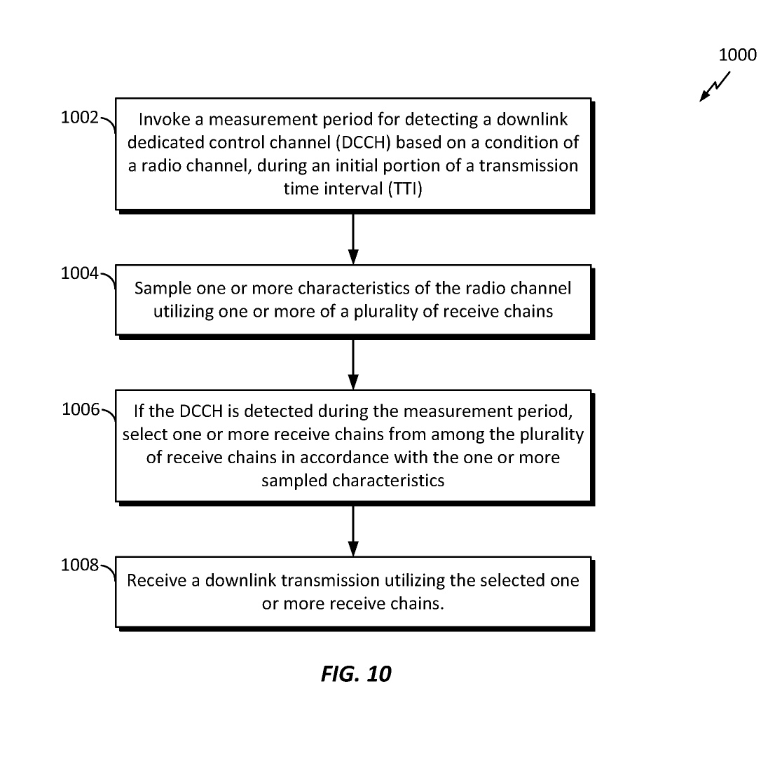

FIG. 10 is a flow chart illustrating a method 1000 of wireless communication operable at a user equipment 210 configured for selection diversity in accordance with an aspect of the disclosure. In step 1002, a UE 210 invokes a measurement period for detecting a downlink dedicated control channel (DCCH) based on a condition of a radio channel, during an initial portion of a TTI (e.g., see FIG. 6). In step 1004, the UE samples one or more characteristics of the radio channel utilizing one or more of a plurality of receive chains. For example, the radio channel may be a DPCH or CPICH. In step 1006, if the DCCH is detected during the measurement period, the UE selects one or more receive chains from among the plurality of receive chains in accordance with the one or more sampled characteristics. In step 1008, the UE receives a downlink transmission utilizing the selected one or more receive chains. According to the method 1000, the UE may reduce its power consumption by performing selection diversity for most part of the TTI when the DCCH is not detected during the measurement period.

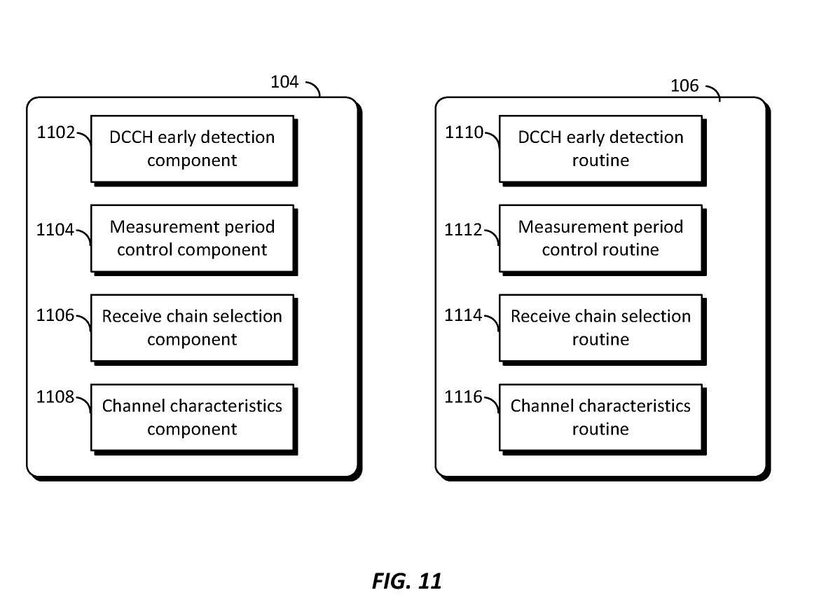

FIG. 11 is a functional block diagram illustrating a processor 104 and a computer-readable medium 106 configured for DCCH-aligned receive diversity in accordance with an aspect of the disclosure. The processor 104 includes a DCCH early detection component 1102, a measurement period control component 1104, a receive chain selection component 1106, and a channel characteristics component 1108. These components of the processor 104 may be implemented with one or more of the various elements shown in FIGS. 1 through 5. The computer-readable medium 106 includes a DCCH early detection routine 1110, a measurement period control routine 1112, a receive chain selection routine 1114, and a channel characteristics routine 1116.

The DCCH early detection component 1102 and the DCCH early detection routine 1110 may provide the means for performing the early DCCH detection described in reference to FIGS. 7-10 above. The measurement period control component 1104 and the measurement period control routine 1112 may provide the means for controlling the measurement period (e.g., Tₘ 602) described in reference to FIGS. 7-10 above. The receive chain selection component 1106 and the receive chain selection routine 1114 may provide the means for controlling (e.g., enable/disable) the receive chains (e.g., RX chain 502, 504) described in reference to FIGS. 7-10 above. The channel characteristics component 1108 and the channel characteristics routine 1116 may provide the means for determining and utilizing the channel characteristics and conditions as described in reference to FIGS. 7-10 above.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication operable at a user equipment (UE) configured for selection diversity, the method comprising:
invoking a measurement period for detecting a downlink dedicated control channel (DCCH) based on a condition of a radio channel, during an initial portion of a transmission time interval (TTI);
sampling one or more characteristics of the radio channel utilizing one or more of a plurality of receive chains;
if the DCCH is detected during the measurement period, selecting one or more receive chains from among the plurality of receive chains in accordance with the one or more sampled characteristics; and
receiving a downlink transmission utilizing the selected one or more receive chains.

2. The method of claim 1, wherein the sampled one or more characteristics comprise at least one of a signal-to-interference ratio estimate (SIRE) of a downlink dedicated physical channel (DPCH), a signal-to-noise ratio (SNR) of a common pilot channel (CPICH), a ratio of received pilot energy (Ec) to total received energy (Io), a geometry of a cell, or a traffic-to-pilot ratio (TPR).

3. The method of claim 2, further comprising:
if the SIRE is larger than a signal-to-interference ratio target (SIRT) of the DPCH by a predetermined amount, reducing the measurement period from a first duration to a second duration; and
if the SIRE is lower than the SIRT of the DPCH by a predetermined amount or the TPR is larger than a predetermined value, forgoing the measurement period and receiving the downlink transmission utilizing all of the receive chains.

4. The method of claim 1, further comprising:
if the DCCH is detected, performing combination diversity utilizing all of the receive chains.

5. The method of claim 1, further comprising utilizing all of the receive chains for detecting the DCCH during the measurement period at a time in alignment with the start of the TTI.

6. The method of claim 1, further comprising selectively adjusting the measurement period from a first duration to a second duration in accordance with the sampled one or more characteristics of the radio channel.

7. The method of claim 1, further comprising dynamically altering a period for invoking the measurement period in accordance with the sampled one or more characteristics of the radio channel.

8. An apparatus configured for selection diversity, the apparatus comprising:
means for invoking a measurement period for detecting a downlink dedicated control channel (DCCH) based on a condition of a radio channel, during an initial portion of a transmission time interval (TTI);
means for sampling one or more characteristics of the radio channel utilizing one or more of a plurality of receive chains;
if the DCCH is detected during the measurement period, means for selecting one or more receive chains from among the plurality of receive chains in accordance with the one or more sampled characteristics; and
means for receiving a downlink transmission utilizing the selected one or more receive chains.

9. The apparatus of claim 8, wherein the sampled one or more characteristics comprise at least one of a signal-to-interference ratio estimate (SIRE) of a downlink dedicated physical channel (DPCH), a signal-to-noise ratio (SNR) of a common pilot channel (CPICH), a ratio of received pilot energy (Ec) to total received energy (Io), a geometry of a cell, or a traffic-to-pilot ratio (TPR).

10. The apparatus of claim 9, further comprising:
if the SIRE is larger than a signal-to-interference ratio target (SIRT) of the DPCH by a predetermined amount, means for reducing the measurement period from a first duration to a second duration; and
if the SIRE is lower than the SIRT of the DPCH by a predetermined amount or the TPR is larger than a predetermined value, means for forgoing the measurement period and receiving the downlink transmission utilizing all of the receive chains.

11. The apparatus of claim 8, further comprising:
if the DCCH is detected, means for performing combination diversity utilizing all of the receive chains.

12. The apparatus of claim 8, further comprising means for utilizing all of the receive chains for detecting the DCCH during the measurement period at a time in alignment with the start of the TTI.

13. The apparatus of claim 8, further comprising means for selectively adjusting the measurement period from a first duration to a second duration in accordance with the sampled one or more characteristics of the radio channel.

14. The apparatus of claim 8, further comprising means for dynamically altering a period for invoking the measurement period in accordance with the sampled one or more characteristics of the radio channel.

15. An apparatus configured for selection diversity, the apparatus comprising:
at least one processor;
a communication interface coupled to the at least one processor; and
a memory coupled to the at least one processor,
wherein the at least one processor is configured to:
invoke a measurement period for detecting a downlink dedicated control channel (DCCH) based on a condition of a radio channel, during an initial portion of a transmission time interval (TTI);
sample one or more characteristics of the radio channel utilizing one or more of a plurality of receive chains;
if the DCCH is detected during the measurement period, select one or more receive chains from among the plurality of receive chains in accordance with the one or more sampled characteristics; and
receive a downlink transmission utilizing the selected one or more receive chains.

16. The apparatus of claim 15, wherein the sampled one or more characteristics comprise at least one of a signal-to-interference ratio estimate (SIRE) of a downlink dedicated physical channel (DPCH), a signal-to-noise ratio (SNR) of a common pilot channel (CPICH), a ratio of received pilot energy (Ec) to total received energy (Io), a geometry of a cell, or a traffic-to-pilot ratio (TPR).

17. The apparatus of claim 16, wherein
if the SIRE is larger than a signal-to-interference ratio target (SIRT) of the DPCH by a predetermined amount, the at least one processor is further configured to reduce the measurement period from a first duration to a second duration; and
if the SIRE is lower than the SIRT of the DPCH by a predetermined amount or the TPR is larger than a predetermined value, the at least one processor is further configured to forgo the measurement period and receive the downlink transmission utilizing all of the receive chains.

18. The apparatus of claim 15, wherein
if the DCCH is detected, the at least one processor is further configured to perform combination diversity utilizing all of the receive chains.

19. The apparatus of claim 15, wherein the at least one processor is further configured to utilize all of the receive chains for detecting the DCCH during the measurement period at a time in alignment with the start of the TTI.

20. The apparatus of claim 15, wherein the at least one processor is further configured to selectively adjust the measurement period from a first duration to a second duration in accordance with the sampled one or more characteristics of the radio channel.

21. The apparatus of claim 15, wherein the at least one processor is further configured to dynamically alter a period for invoking the measurement period in accordance with the sampled one or more characteristics of the radio channel.

22. A computer-readable medium comprising code for causing a user equipment (UE) configured for selection diversity to:
invoke a measurement period for detecting a downlink dedicated control channel (DCCH) based on a condition of a radio channel, during an initial portion of a transmission time interval (TTI);
sample one or more characteristics of the radio channel utilizing one or more of a plurality of receive chains;
if the DCCH is detected during the measurement period, select one or more receive chains from among the plurality of receive chains in accordance with the one or more sampled characteristics; and
receive a downlink transmission utilizing the selected one or more receive chains.

23. The computer-readable medium of claim 22, wherein the sampled one or more characteristics comprise at least one of a signal-to-interference ratio estimate (SIRE) of a downlink dedicated physical channel (DPCH), a signal-to-noise ratio (SNR) of a common pilot channel (CPICH), a ratio of received pilot energy (Ec) to total received energy (Io), a geometry of a cell, or a traffic-to-pilot ratio (TPR).

24. The computer-readable medium of claim 23, further comprising code for causing the UE to:
if the SIRE is larger than a signal-to-interference ratio target (SIRT) of the DPCH by a predetermined amount, reduce the measurement period from a first duration to a second duration; and
if the SIRE is lower than the SIRT of the DPCH by a predetermined amount or the TPR is larger than a predetermined value, forgo the measurement period and receive the downlink transmission utilizing all of the receive chains.

25. The computer-readable medium of claim 22, further comprising code for causing the UE to:
if the DCCH is detected, perform combination diversity utilizing all of the receive chains.

26. The computer-readable medium of claim 22, further comprising code for causing the UE to utilize all of the receive chains for detecting the DCCH during the measurement period at a time in alignment with the start of the TTI.

27. The computer-readable medium of claim 22, further comprising code for causing the UE to selectively adjust the measurement period from a first duration to a second duration in accordance with the sampled one or more characteristics of the radio channel.

28. The computer-readable medium of claim 22, further comprising code for causing the UE to dynamically alter a period for invoking the measurement period in accordance with the sampled one or more characteristics of the radio channel.
